(19) United States
(12) Patent Application Publication
(10) Pub. No.: US 2012/0244293 A1
(43) Pub. Date: Sep. 27, 2012

(54) METHOD FOR PRODUCING POLYMER SHEET HAVING THREE-DIMENSIONAL PATTERN ON SURFACE

(75) Inventors: Kunio Nagasaki, Ibaraki-shi (JP); Yusuke Sugino, Ibaraki-shi (JP); Kohei Doi, Ibaraki-shi (JP)

(73) Assignee: NITTO DENKO CORPORATION, Ibaraki-shi, Osaka (JP)

(21) Appl. No.: 13/504,625

(22) PCT Filed: Oct. 14, 2010
(86) PCT No.: PCT/JP2010/068540

§ 371 Date: Apr. 27, 2012

(30) Foreign Application Priority Data
Oct. 29, 2009 (JP) 2009-248367

(51) Int. Cl. B05D 5/00; B05D 3/06; B05D 3/00

(52) U.S. Cl. 427/510; 427/256; 427/487

(57) ABSTRACT

Provided is a method for simply producing a polymer sheet having a three-dimensional pattern on surface. The method produces such a polymer sheet having a three-dimensional pattern on surface by applying a polymerizable composition to one surface of a polymer sheet and allowing the surface to have a three-dimensionally altered shape; and thereafter performing polymerization/curing to form a three-dimensional pattern on the surface of the polymer sheet. The polymerizable composition includes a monomer mixture including at least one polymerizable monomer absorbable by the polymer sheet, or a partial polymer of the monomer mixture as an essential component.

### TECHNICAL FIELD

The present invention relates to a method for producing a polymer sheet having a three-dimensional pattern on surface.

### BACKGROUND ART

Polymer sheets have been used in a variety of applications such as tablecloths, flooring materials, and wall-coverings. When used in tablecloths, flooring materials, wall-coverings, and other applications, some of polymer sheets may be designed to have a three-dimensional pattern on surface so as to improve a graphical design function. In general, transfer molding is known as an exemplary technique for forming a three-dimensional pattern on a surface of a polymer sheet. In the transfer molding, the polymer sheet is stamped onto, for example, a mold, sheet, or roll having asperities, the stamped polymer sheet is thermally deformed to transfer the reversed pattern of asperities to the surface of the polymer sheet (e.g., Patent Literature (PTL) 1). This technique, however, requires heat to soften the polymer, thereby requires a large quantity of heat energy, needs a certain cooling time or a large quantity of cooling energy after the transfer of the pattern to the polymer sheet, and requires a mold-release treatment in the mold and/or the polymer sheet, thus being problematic.

Independently, the formation of a three-dimensional pattern also has the advantage of providing a larger surface area per unit area.

There is known a polymer article containing an immiscible or incompatible material unevenly distributed (see PTL 2). The polymer article has asperities on surface. This technique have been made by focusing a phenomenon in which, when a polymerizable composition including an immiscible material is applied to a monomer-absorptive layer, the immiscible material segregates on surface. The asperities on surface, however, vary depending on the shape and size of the immiscible material; and a pattern of asperities can be formed on surface according to this technique only in the case that microparticles as the immiscible material are dispersed in a polymerizable composition for constituting the polymer article.

### CITATION LIST

### Patent Literature

PTL 1: Japanese Unexamined Patent Application Publication (JP-A) No. H11-245294

PTL 2: Japanese Unexamined Patent Application Publication (JP-A) No. 2008-6817

### SUMMARY OF INVENTION

### Technical Problem

Accordingly, an object of the present invention is to provide a method for simply producing a polymer sheet having a three-dimensional pattern on surface.

### Solution to Problem

After intensive investigations to achieve the object, the present inventors found that a polymer sheet having a three-dimensional pattern on surface can be simply produced by applying a polymerizable composition to one surface of a polymer sheet, the polymerizable composition including, as an essential component, a monomer mixture including at least one polymerizable monomer absorbable by the polymer sheet, or a partial polymer of the monomer mixture, and allowing the surface to which the composition is applied to have a three-dimensionally altered shape, followed by polymerization/curing. The present invention has been made based on these findings.

Specifically, the present invention provides a method for producing a polymer sheet having a three-dimensional pattern on surface. The method includes the steps of applying a polymerizable composition to one surface of a polymer sheet and allowing the surface to have a three-dimensionally altered shape, the polymerizable composition including a monomer mixture or a partial polymer thereof as an essential component, the monomer mixture including at least one polymerizable monomer absorbable by the polymer sheet; and thereafter performing polymerization/curing to form a three-dimensional pattern on the surface of the polymer sheet.

In another embodiment of the method for producing a polymer sheet having a three-dimensional pattern, the method includes the steps of applying the polymerizable composition to one surface of the polymer sheet and allowing the surface to have a three-dimensionally altered shape without affixation of a cover film onto the applied surface, the polymerizable composition including the monomer mixture or a partial polymer thereof as an essential component, the monomer mixture including at least one polymerizable monomer absorbable by the polymer sheet; and thereafter performing polymerization/curing.

In yet another embodiment of the method for producing a polymer sheet having a three-dimensional pattern, the polymerizable composition applied to one surface of the polymer sheet may be left for one minute or longer before being subjected to polymerization.

In still another embodiment of the method for producing a polymer sheet having a three-dimensional pattern, the polymerizable composition may further include at least one material unabsorbable by the polymer sheet.

In another embodiment of the method for producing a polymer sheet having a three-dimensional pattern, either one or both of the polymer sheet and the polymerizable composition may include a photoinitiator.

In yet another embodiment of the method for producing a polymer sheet having a three-dimensional pattern, the polymerization/curing may be performed through irradiation with active energy ray.

In another embodiment of the method for producing a polymer sheet having a three-dimensional pattern, the active energy ray may be ultraviolet ray.

### Advantageous Effects of Invention

The method for producing a polymer sheet having a three-dimensional pattern on surface according to the present invention, as having the above-mentioned configuration, can simply produce a polymer sheet having a three-dimensional pattern on surface.

### BRIEF DESCRIPTION OF DRAWINGS

FIG. 1 is a scanning electron photomicrograph illustrating the cross section of part of Example 1.

FIG. 2 is a scanning electron photomicrograph illustrating part of the surface of Example 1.

FIG. 3 is a scanning electron photomicrograph illustrating part of the surface of Example 2.

FIG. 4 is a scanning electron photomicrograph illustrating part of the surface of Example 3.

FIG. 5 is a scanning electron photomicrograph illustrating part of the surface of Example 4.

FIG. 6 is a scanning electron photomicrograph illustrating part of the surface of Example 5.

FIG. 7 is a scanning electron photomicrograph illustrating part of the surface of Example 5.

FIG. 8 is a scanning electron photomicrograph illustrating the cross section of part of Example 5.

FIG. 9 is a scanning electron photomicrograph illustrating the cross section of part of Example 5.

FIG. 10 is a photograph illustrating the surface of Example 5.

FIG. 11 is a scanning electron photomicrograph illustrating the surface of Example 6.

FIG. 12 is a scanning electron photomicrograph illustrating the cross section of part of Example 6.

### DESCRIPTION OF EMBODIMENTS

The method for producing a polymer sheet having a three-dimensional pattern on surface according to the present invention gives a polymer sheet having a three-dimensional pattern by applying a polymerizable composition to one surface of a polymer sheet, the polymerizable composition including, as an essential component, a monomer mixture including at least one polymerizable monomer absorbable by the polymer sheet, or a partial polymer of the monomer mixture, allowing the surface to have a three-dimensionally altered shape, and performing polymerization and curing to form a three-dimensional pattern on the surface. As used herein the term “sheet” also includes one in the form of tape, namely, includes a “tape.” A coated layer of polymerizable composition immediately after coating, which is formed by applying a polymerizable composition to one surface of a polymer sheet, is also referred to as a “polymerizable-composition-coating layer.” Hereinafter “method for producing a polymer sheet having a three-dimensional pattern on surface according to the present invention” is also simply referred to as a “production method according to the present invention.”

The production method according to the present invention includes, as essential steps, the step of applying a polymerizable composition to one surface of a polymer sheet and allowing the surface to have a three-dimensionally altered shape, the polymerizable composition including, as an essential component, a monomer mixture including at least one polymerizable monomer absorbable by the polymer sheet, or a partial polymer of the monomer mixture [Step (i)]; and the step of subjecting the resulting article to polymerization to form a three-dimensional pattern on the surface [Step (ii)].

### (Polymer Sheet)

The polymer sheet is a sheet composed of a single-layer polymer layer and is capable of absorbing at least one of polymerizable monomer(s) from the polymerizable composition. Specifically, as used herein the term “polymer sheet” refers to a polymer in the form of sheet or film, which serves as a monomer-absorptive layer. As used herein the term “monomer-absorptive layer” refers to a layer which interacts with at least one of the polymerizable monomer(s), absorbs and allows the at least one polymerizable monomer to migrate into the inside of the layer. In other words, the polymer sheet is a layer capable of incorporating the at least one polymerizable monomer thereinto. In the polymer sheet, a surface provided by the monomer-absorptive layer is a surface which will absorb the at least one polymerizable monomer, i.e., a monomer-absorptive surface.

The polymer sheet may be present as a monomer-absorptive layer provided on at least one side of a backing (base material; or support) mentioned later. Specifically, the polymer sheet may be a monomer-absorptive layer in a multilayer sheet including the polymer sheet and the after-mentioned backing. Such a multilayer sheet is advantageous in handleability and workability.

In relationship between a polymer sheet and a polymerizable monomer, whether the polymer sheet corresponds to a monomer-absorptive layer with respect to the polymerizable monomer is determined based on whether or not the following condition is satisfied. Specifically, the determination is made based on whether or not the polymer sheet has a weight of 2 times or more the initial weight when immersed in an excess amount (300 times by weight or more that of the polymer sheet) of the polymerizable monomer at 25° C. for 75 seconds; and the polymer sheet has not disappeared by dissolution and has a weight of 2 times or more the initial weight when immersed in an excess amount (300 times by weight or more that of the polymer sheet) of the polymerizable monomer at 25° C. for 3 days. When a polymer sheet and a polymerizable monomer satisfy this condition in relationship between them, specifically, when the polymer sheet has a weight of 2 times or more the initial weight in the both cases, the polymer sheet in question can be used in the present invention as a monomer-absorptive layer with respect to the polymerizable monomer.

The polymer sheet serving as a monomer-absorptive layer (polymer layer serving as a monomer-absorptive layer) may be formed using a known or customary technique. Typically, the polymer sheet may be formed by applying a composition for the formation of polymer sheet serving as a monomer-absorptive layer (polymer layer serving as a monomer-absorptive layer) to a predetermined surface of a suitable support, such as a surface of the after-mentioned backing (polymer-sheet backing) or a surface of a separator which surface has been releasably treated; and subjecting the applied composition to drying and/or polymerization according to necessity. The composition for the formation of the polymer sheet serving as a monomer-absorptive layer (polymer layer serving as a monomer-absorptive layer) is also referred to as a “monomer-absorptive-layer-forming composition.”

Examples of the monomer-absorptive-layer-forming composition include, but are not limited to, monomer-absorptive-layer-forming compositions each including a polymer as an essential component; and monomer-absorptive-layer-forming compositions each including, as an essential component, a mixture of monomers (monomer mixture) for the formation of a polymer or a partial polymer of the monomer mixture. Specifically, examples of the former ones include so-called “solvent (solvent-borne)” monomer-absorptive-layer-forming compositions; and examples of the latter ones include so-called “active-energy-ray-curable” monomer-absorptive-layer-forming compositions. The monomer-absorptive-layer-forming composition may employ any of crosslinking agents and other various additives according to necessity.

A polymer constituting the polymer sheet is not limited, as long as being capable of absorbing at least one of polymerizable monomer(s) as constitutive component(s) of the polymerizable composition. The polymer may be suitably selected typically from among acrylic polymers, rubber polymers, vinyl alkyl ether polymers, silicone polymers, polyester polymers, polyamide polymers, urethane polymers, fluorocarbon polymers, and epoxy polymers. Of such polymers, acrylic polymers are particularly preferred, typically because they can absorb monomers of a wide range of type, have a strength and other mechanical properties varying in a wide range from soft (flexible) ones to rigid ones, and excel in transparency and weatherability. Specifically, the polymer sheet serving as a monomer-absorptive layer is preferably an acrylic polymer sheet. Each of such polymers may be used alone or in combination.

The polymer sheet serving as a monomer-absorptive layer may also be a pressure-sensitive adhesive layer (self-adhesive layer) including the polymer as a base polymer. Exemplary pressure-sensitive adhesives for the formation of the pressure-sensitive adhesive layer include acrylic pressure-sensitive adhesives, rubber pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorine-containing pressure-sensitive adhesives, and epoxy pressure-sensitive adhesives. In other words, the polymer sheet serving as a monomer-absorptive layer may be a pressure-sensitive adhesive sheet (self-adhesive sheet). When the polymer sheet is a pressure-sensitive adhesive layer and is used in the production method according to the present invention, the resulting polymer sheet having a three-dimensional pattern on surface can exhibit tackiness (adhesiveness).

Of the acrylic polymers, preferred are acrylic polymers each including a (meth)acrylic ester as a monomer component, of which acrylic polymers each including a (meth)acrylic alkyl ester as a principal monomer component (monomer main component) are particularly preferred. Exemplary (meth)acrylic alkyl esters include (meth)acrylic alkyl esters each having a linear or branched-chain alkyl group; and (meth)acrylic alkyl esters each having a cyclic alkyl group. As used herein the term “(meth)acrylic” refers to “acrylic” and/or “methacrylic”, and the same is true for others. Each of different (meth)acrylic alkyl esters may be used alone or in combination.

Exemplary (meth)acrylic alkyl esters each having a linear or branched-chain alkyl group include (meth)acrylic alkyl esters whose alkyl group having 1 to 20 carbon atoms, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Among them, preferred are (meth)acrylic alkyl esters whose alkyl group having 1 to 14 carbon atoms, of which (meth)acrylic alkyl esters whose alkyl group having 1 to 10 carbon atoms are more preferred.

Exemplary (meth)acrylic alkyl esters each having a cyclic alkyl group include cyclopentyl(meth)acrylate, cyclohexyl(meth)acrylate, and isobornyl(meth)acrylate.

The (meth)acrylic alkyl ester(s) is used as a monomer main component for the acrylic polymer, and it is therefore important that the (meth)acrylic alkyl ester(s) is contained in an amount of 60 percent by weight or more, and preferably 80 percent by weight or more, based on the total amount of monomer components for constituting the acrylic polymer.

The acrylic polymer may employ any of copolymerizable monomers such as polar-group-containing monomers and multifunctional monomers as a monomer component. Such a copolymerizable monomer, when used as a monomer component, helps the acrylic polymer typically to have an increased cohesive strength. Each of different copolymerizable monomers may be used alone or in combination.

Examples of the polar-group-containing monomers include carboxyl-containing monomers such as (meth)acrylic acid, itaconic acid, maleic acid, fumaric acid, crotonic acid, and isocrotonic acid, and anhydrides of them, such as maleic anhydride; hydroxyl-containing monomers including hydroxylalkyl(meth)acrylates such as hydroxyethyl(meth)acrylate, hydroxypropyl(meth)acrylate, and hydroxybutyl(meth)acrylate; amido-containing monomers such as acrylamide, methacrylamide, N,N-dimethyl(meth)acrylamide, N-methylol(meth)acrylamide, N-methoxymethyl(meth)acrylamide, and N-butoxymethyl(meth)acrylamide; amino-containing monomers such as aminoethyl(meth)acrylate, dimethylaminoethyl(meth)acrylate, and t-butylaminoethyl(meth)acrylate; glycidyl-containing monomers such as glycidyl(meth)acrylate and methylglycidyl(meth)acrylate; cyano-containing monomers such as acrylonitrile and methacrylonitrile; heterocycle-containing vinyl monomers such as N-vinyl-2-pyrrolidone, (meth)acryloylmorpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate monomers such as methoxyethyl(meth)acrylate and ethoxyethyl(meth)acrylate; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Of polar-group-containing monomers, carboxyl-containing monomers such as acrylic acid, or anhydrides of them are preferred.

Polar-group-containing monomer(s) may be used in an amount of 30 percent by weight or less (e.g., from 1 to 30 percent by weight), and preferably from 3 to 20 percent by weight, based on the total amount of monomer components for constituting the acrylic polymer. Polar-group-containing monomer(s), if used in an amount of more than 30 percent by weight, may cause the polymer to have an excessively high cohesive strength and may thereby cause problems typically in flexibility. Polar-group-containing monomer(s), if used in an excessively low amount (e.g., less than 1 percent by weight based on the total amount of monomer components for constituting the acrylic polymer), may not sufficiently help the resulting polymer to have a satisfactory cohesive strength and to have satisfactory strength. In addition, the resulting polymer sheet may have poor handleability.

Examples of the multifunctional monomers include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylates, polyester acrylates, and urethane acrylates.

Multifunctional monomer(s) may be used in an amount of 20 percent by weight or less (e.g., from 0.01 to 20 percent by weight), and preferably from 0.02 to 1 percent by weight, based on the total amount of monomer components for constituting the acrylic polymer. Multifunctional monomer(s), if used in an amount of more than 20 percent by weight based on the total amount of monomer components for constituting the acrylic polymer, may cause, for example, the acrylic polymer to have an excessively high cohesive strength, and this may impair the monomer absorptivity. Multifunctional monomer(s), if used in an excessively low amount (e.g., less than 0.01 percent by weight based on the total amount of monomer components for constituting the acrylic polymer), may not sufficiently help, for example, the acrylic polymer to have a satisfactory cohesive strength or may cause the acrylic polymer to be dissolved in polymerizable monomers.

Examples of copolymerizable monomers other than the polar-group-containing monomers and multifunctional monomers include vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride.

Though not limited, the polymer constituting the polymer sheet serving as a monomer-absorptive layer is preferably a polymer including, as a constitutional unit thereof, at least one of polymerizable monomers to be contained in the polymerizable composition mentioned later. When the polymer and the at least one polymerizable monomer possess an identical constitutional unit, this helps the polymer sheet to absorb the polymerizable monomer more satisfactorily and thereby helps a three-dimensional pattern to be formed on surface more readily.

As is described later, the polymerizable composition is preferably a polymerizable acrylic composition including, as an essential component, an acrylic monomer mixture containing at least one acrylic monomer as a principal monomer, or a partial polymer of the acrylic monomer mixture. Also for this reason, the polymer sheet is preferably an acrylic polymer sheet (acrylic polymer layer).

The acrylic polymer may be prepared by subjecting the monomer component(s) to polymerization (copolymerization) according to a known or customary polymerization technique. Exemplary polymerization techniques include solution polymerization, emulsion polymerization, bulk polymerization, polymerization through irradiation with an active energy ray (active energy ray polymerization, photopolymerization). Among them, active energy ray polymerization techniques are preferred, because they do not need the use of organic solvents, save energy, and can readily give a relatively thick polymer layer (polymer sheet); of which ultraviolet ray polymerization technique through the irradiation with an ultraviolet ray is more preferred.

Preparation of the acrylic polymer may use any of polymerization initiators such as thermal initiators and photoinitiators, according to the type of the polymerization reaction. As the preparation of the polymer layer is preferably performed by active energy ray polymerization as described above, the monomer-absorptive-layer-forming composition preferably includes a photoinitiator. Each of different polymerization initiators may be used alone or in combination.

Examples of the photoinitiator usable herein include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators. Each of different photoinitiators may be used alone or in combination.

Specifically, exemplary ketal photoinitiators include 2,2-dimethoxy-1,2-diphenylethan-1-one [e.g., trade name “IRGACURE 651” (supplied by Ciba Japan Ltd.)]. Exemplary acetophenone photoinitiators include 1-hydroxycyclohexylphenyl ketone [e.g., trade name “IRGACURE 184” (supplied by Ciba Japan Ltd.)], 2,2-diethoxyacetophenone, 2,2-dimethoxy-2-phenylacetophenone, 4-phenoxydichloroacetophenone, and 4-(t-butyl)dichloroacetophenone. Exemplary benzoin ether photoinitiators include benzoin methyl ether, benzoin ethyl ether, benzoin propyl ether, benzoin isopropyl ether, and benzoin isobutyl ether. Exemplary acylphosphine oxide photoinitiators usable herein include trade name “Lucirin TPO” (supplied by BASF AG). Exemplary α-ketol photoinitiators include 2-methyl-2-hydroxypropiophenone and 1-[4-(2-hydroxyethyl)phenyl]-2-methylpropan-1-one. Exemplary aromatic sulfonyl chloride photoinitiators include 2-naphthalenesulfonyl chloride. Exemplary photoactive oxime photoinitiators include 1-phenyl-1,1-propanedione-2-(o-ethoxycarbonyl)-oxime. The benzoin photoinitiators include, for example, benzoin. Exemplary benzil photoinitiators include benzil. Exemplary benzophenone photoinitiators include benzophenone, benzoylbenzoic acid, 3,3′-dimethyl-4-methoxybenzophenone, polyvinylbenzophenone, and α-hydroxycyclohexyl phenyl ketone. Exemplary thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Though not critical, photoinitiator(s) may be used in an amount selected within the range of from 0.01 to 5 parts by weight, and preferably from 0.05 to 3 parts by weight, per 100 parts by weight of the total amount of monomer components for constituting the acrylic polymer.

Exemplary active energy rays for use in the polymerization through irradiation with an active energy ray include ionizing radiation such as alpha rays, beta rays, gamma rays, neutron beams, and electron beams; and ultraviolet rays, of which ultraviolet rays are preferred. Conditions of active energy ray irradiation, such as irradiation energy, irradiation time, and irradiation process, are not limited, as long as capable of activating the photoinitiator(s) to cause a polymerization reaction.

Examples of the thermal initiators include azo polymerization initiators [e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine)disulfate, and 2,2′-azobis(N,N′-dimethyleneisobutylamidine)dihydrochloride], peroxide polymerization initiators (e.g., dibenzoyl peroxide and tert-butyl permaleate), and redox polymerization initiators (e.g., an organic peroxide in combination with a vanadium compound; an organic peroxide in combination with dimethylaniline; and a metal salt of naphthenic acid in combination with butyraldehyde, aniline, or acetylbutyrolactone). Thermal initiators may be used in an amount not critical, within such a rage that they are usable as thermal initiators. A redox polymerization initiator, when used as the thermal initiator, enables polymerization at room temperature.

A solvent for use in polymerization of the acrylic polymer as a solution can be any of known or customary organic solvents. Exemplary organic solvents usable herein include ester solvents such as ethyl acetate and methyl acetate; ketone solvents such as acetone and methyl ethyl ketone; alcohol solvents such as methanol, ethanol, and butanol; hydrocarbon solvents such as cyclohexane, hexane, and heptane; and aromatic solvents such as toluene and xylenes. Each of such organic solvents may be used alone or in combination.

The monomer-absorptive-layer-forming composition may further include a crosslinking agent. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred for satisfactory handleability. Each of different crosslinking agents may be used alone or in combination.

Examples of the isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanate; as well as a tolylene diisocyanate adduct of trimethylolpropane [trade name “CORONATE L” supplied by Nippon Polyurethane Industry Co., Ltd.] and a hexamethylene diisocyanate adduct of trimethylolpropane [trade name “CORONATE HL” supplied by Nippon Polyurethane Industry Co., Ltd.].

The epoxy crosslinking agents include, for example, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether, and bisphenol-S diglycidyl ether, as well as epoxy resins each having two or more epoxy groups per molecule.

The monomer-absorptive-layer-forming composition may further include one or more suitable additives according to necessity. Examples of such additives include surfactants (e.g., ionic surfactants, silicone surfactants, and fluorochemical surfactants), tackifiers (e.g., those including a rosin derivative resin, a polyterpene resin, a petroleum resin, or an oil-soluble phenol resin and being solid, semisolid, or liquid at room temperature), plasticizers, fillers, age inhibitors, antioxidants, and colorants (e.g., pigments and dyestuffs). The amounts of such additives may be chosen within ranges not adversely affecting advantageous effects of the present invention.

The monomer-absorptive-layer-forming composition preferably has a formulation identical or similar to that of the after-mentioned polymerizable composition from the points of good workability and easy formation of a three-dimensional pattern on surface due to easy migration of the polymerizable monomer.

Specific examples of the monomer-absorptive-layer-forming composition, when having a formulation similar to that of the polymerizable composition, include a monomer-absorptive-layer-forming composition containing at least one of the polymerizable monomer(s) as a constitutional component; and a monomer-absorptive-layer-forming composition containing, as a constitutional component, a monomer having a partial structure which features the monomer and which is identical to that of at least one of the polymerizable monomer(s) in the polymerizable composition. Examples of the featuring partial structure include acrylate structure of an acrylic monomer; and epoxy structure of an epoxy monomer.

In a preferred embodiment of the production method according to the present invention, the polymer constituting the polymer sheet serving as a monomer-absorptive layer is preferably an acrylic polymer, as is described above. Accordingly, the monomer-absorptive-layer-forming composition is preferably an acrylic monomer-absorptive-layer-forming composition which will form an acrylic polymer.

The polymer sheet serving as a monomer-absorptive layer may be formed by any process chosen without limitation from among known or customary processes.

When the monomer-absorptive-layer-forming composition (e.g., a solution of monomer-absorptive-layer-forming composition) is one including an acrylic polymer as an essential component, examples of the formation process include a direct application process in which the monomer-absorptive-layer-forming composition is applied to a predetermined surface (e.g., at least one surface of the after-mentioned polymer-sheet backing) so as to have a predetermined dry thickness, and the applied composition is dried and/or cured according to necessity; and a transfer process in which the monomer-absorptive-layer-forming composition is applied to a suitable release liner so as to have a predetermined dry thickness, the applied composition is dried and/or cured according to necessity to form a polymer sheet thereon, and the polymer sheet is transferred to a predetermined surface (e.g., at least one surface of the after-mentioned polymer-sheet backing).

When the monomer-absorptive-layer-forming composition is one including a mixture of monomer components (monomer mixture) for constituting the acrylic polymer, or a partial polymer of the monomer mixture as an essential component, examples of the formation process include a direct application process in which the monomer-absorptive-layer-forming composition is applied to a predetermined surface (e.g., at least one surface of the after-mentioned polymer-sheet backing), the applied composition is irradiated with an active energy ray to thereby form a polymer sheet through curing with the active energy ray; and a transfer process in which the monomer-absorptive-layer-forming composition is applied to a suitable release liner, the applied composition is irradiated with an active energy ray to form a polymer sheet through curing with the active energy ray, and the polymer sheet is transferred to a predetermined surface (e.g., at least one surface of the after-mentioned polymer-sheet backing). These formation processes may further include a drying step according to necessity.

Among them, the polymer sheet is preferably formed by the process through curing with an active energy ray, because such process does not need the use of organic solvents, saves energy, and can give a relatively thick polymer sheet.

The application of the monomer-absorptive-layer-forming composition may employ a customary coater such as comma roll coater, die roll coater, rotogravure roll coater, reverse roll coater, kiss-contact roll coater, dip roll coater, bar coater, knife coater, or spray coater.

The polymer sheet serving as a monomer-absorptive layer has such a thickness (thickness of the polymer sheet before the application of the polymerizable composition) that the ratio in thickness of the polymerizable-composition-coating layer (layer of the polymerizable composition immediately after the application thereof to one surface of the polymer sheet) to the polymer sheet is preferably from 0.51 to 100, and particularly preferably from 1 to 50, for easy formation of the three-dimensional pattern. If the ratio is less than 0.51, the formation of the three-dimensional pattern may be impeded. In contrast, if the ratio is more than 100, the three-dimensional pattern may not appear on the surface. Specifically, the polymer sheet has a thickness of preferably from 1 to 1000 μm, more preferably from 2 to 500 μm, and particularly preferably from 5 to 200 μm, typically for satisfactory handleability.

The polymer sheet serving as a monomer-absorptive layer may be arranged on at least one side of a backing (support; polymer-sheet backing), as described above. Examples of the backing (polymer-sheet backing) in this case include suitable thin articles including paper-based backings such as papers; fibrous backings such as cloths, nonwoven fabrics, and nets; metallic backings such as metallic foils and metal sheets; plastic backings such as plastic films or sheets; rubber backings such as rubber sheets; foams such as foam sheets (expanded sheets); and laminated structures of them (e.g., a laminated structure of a plastic backing and another backing, and a laminated structure of plastic films (or sheets) with each other. Among them, plastic backings such as plastic films and sheets are advantageously usable as the backing. Exemplary materials for such plastic films and sheets include olefinic resins each including an α-olefin as a monomer component, such as polyethylenes (PEs), polypropylenes (PPs), ethylene-propylene copolymers, and ethylene-vinyl acrylate copolymers (EVAs); polyester resins such as poly(ethylene terephthalate)s (PETs), poly(ethylene naphthalate)s (PENs), and poly(butylene terephthalate)s (PBTs); poly(vinyl chloride)s (PVC); vinyl acrylate resins; poly(phenylene sulfide)s (PPSs); amide resins such as polyamides (nylons) and wholly aromatic polyamides (aramids); polyimide resins; and poly(ether ether ketone)s (PEEKS). Each of such materials may be used alone or in combination.

When a plastic backing is used as the backing, elongation percentage and other deformation properties of the plastic backing may be controlled typically by drawing treatment. When the polymer sheet is formed through curing with an active energy ray, the backing to be used is preferably one that does not inhibit the transmission of the active energy ray.

For increased adhesion to the polymer layer, the surface of the backing may be subjected to a customary surface treatment including corona treatment, chromate treatment, exposure to ozone, exposure to flame, exposure to a high-voltage electric shock, treatment with ionizing radiation, or another oxidation treatment by a chemical or physical process; or may for example be subjected to a coating treatment typically with a primer or a release agent.

Though not critical, the thickness of the backing may be suitably selected according typically to strength, flexibility, and intended use and is, for example, generally about 1000 μm or less (e.g., from about 1 to about 1000 μm), preferably from about 1 to about 500 μm, and more preferably from about 3 to about 300 μm. The backing may have either a single-layer structure or a multilayer structure.

When the polymer sheet serving as a monomer-absorptive layer is provided on at least one side of the backing (polymer-sheet backing), a third layer may be arranged between the polymer sheet and the backing. Examples of the third layer include an adhesive layer for increased adhesiveness; and an electroconductive layer for imparting antistatic properties.

### (Polymerizable Composition)

The polymerizable composition is a composition including a monomer mixture containing at least one polymerizable monomer, or a partial polymer of the monomer mixture as an essential component. The polymerizable composition is applied onto the polymer sheet serving as a monomer-absorptive layer. As used herein the term “monomer mixture” refers to a mixture composed of one or more monomer components alone and includes one composed of only one monomer component. The term “partial polymer” refers to a composition corresponding to the monomer mixture, except for one or more components of the monomer mixture having been partially polymerized.

It is important that the polymerizable monomer(s) is a compound that is polymerizable by using light energy or heat energy, regardless of reaction mechanism such as radical polymerization or cationic polymerization. The production method according to the present invention should essentially select and employ at least one polymerizable monomer which is capable of interacting with the polymer sheet serving as a monomer-absorptive layer, being absorbed by the polymer sheet, and migrating into the layer (sheet).

Examples of such polymerizable monomers include radically polymerizable monomers such as acrylic monomers to form acrylic polymers; cationically polymerizable monomers such as epoxy monomers to form epoxy resins, oxetane monomers to form oxetane resins, and vinyl ether monomers to form vinyl ether resins; combinations of a polyisocyanate and a polyol to form urethane resins; and combinations of a polycarboxylic acid and a polyol to form polyester resins. Each of different polymerizable monomers may be used alone or in combination.

Among them, acrylic monomers are preferred as the polymerizable monomer(s) for use in the production method according to the present invention, because the acrylic monomers give a high polymerization rate even under relatively mild reaction conditions (e.g., temperature and irradiance). Specifically, the polymerizable composition is preferably a polymerizable acrylic composition (acrylic polymerizable composition) which includes, as an essential component, a monomer mixture containing an acrylic monomer as a principal component, or a partial polymer of the monomer mixture (an acrylic monomer mixture or a partial polymer thereof).

The acrylic monomer is preferably a (meth)acrylic ester, and particularly preferably a (meth)acrylic alkyl ester having an alkyl group (a (meth)acrylic alkyl ester having a linear or branched-chain alkyl group or a (meth)acrylic alkyl ester having a cyclic alkyl group. As used herein the term “(meth)acrylic” refers to “acrylic” and/or “methacrylic”, and the same is true for others. Each of different (meth)acrylic alkyl esters may be used alone or in combination.

Exemplary (meth)acrylic alkyl esters each having a linear or branched-chain alkyl group include (meth)acrylic alkyl esters whose alkyl group having 1 to 20 carbon atoms, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Among them, preferred are (meth)acrylic alkyl esters whose alkyl group having 1 to 14 carbon atoms, of which (meth)acrylic alkyl esters whose alkyl group having 1 to 10 carbon atoms are more preferred.

Exemplary (meth)acrylic alkyl esters each having a cyclic alkyl group include cyclopentyl(meth)acrylate, cyclohexyl(meth)acrylate, and isobornyl(meth)acrylate.

When the polymerizable composition is a polymerizable acrylic composition, it is important that the (meth)acrylic ester(s) [particularly (meth)acrylic alkyl ester(s) having an alkyl group (e.g., a linear or branched-chain alkyl group or a cyclic alkyl group)] occupies 60 percent by weight or more, and preferably 90 percent by weight or more, of total constitutive monomer components of the acrylic monomer mixture or a partial polymer thereof.

The polymerizable acrylic composition may further include, in addition to the acrylic monomer(s) as a principal component, any of copolymerizable monomers such as polar-group-containing monomers and multifunctional monomers, as a component of the acrylic monomer mixture or a partial polymer thereof. Typically, such a copolymerizable monomer, when used, helps the composition to have an increased cohesive strength. Each of different copolymerizable monomers may be used alone or in combination.

Examples of the polar-group-containing monomers include carboxyl-containing monomers such as (meth)acrylic acid, itaconic acid, maleic acid, fumaric acid, crotonic acid, and isocrotonic acid, and anhydrides of them, such as maleic anhydride; hydroxyl-containing monomers including hydroxylalkyl(meth)acrylates such as hydroxyethyl(meth)acrylate, hydroxypropyl(meth)acrylate, and hydroxybutyl(meth)acrylate; amido-containing monomers such as acrylamide, methacrylamide, N,N-dimethyl(meth)acrylamide, N-methylol(meth)acrylamide, N-methoxymethyl(meth)acrylamide, and N-butoxymethyl(meth)acrylamide; amino-containing monomers such as aminoethyl(meth)acrylate, dimethylaminoethyl(meth)acrylate, and t-butylaminoethyl(meth)acrylate; glycidyl-containing monomers such as glycidyl(meth)acrylate and methylglycidyl(meth)acrylate; cyano-containing monomers such as acrylonitrile and methacrylonitrile; heterocycle-containing vinyl monomers such as N-vinyl-2-pyrrolidone, (meth)acryloylmorpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate monomers such as methoxyethyl(meth)acrylate and ethoxyethyl(meth)acrylate; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Of polar-group-containing monomers, carboxyl-containing monomers such as acrylic acid, or anhydrides of them are preferred.

Such polar-group-containing monomer(s) may be used in an amount of 30 percent by weight or less (e.g., from 1 to 30 percent by weight), and preferably from 3 to 20 percent by weight, based on the total amount of constitutive monomer components of the acrylic monomer mixture or a partial polymer thereof. Polar-group-containing monomer(s), if used in an amount of more than 30 percent by weight, may cause the resulting polymer to have an excessively high cohesive strength, and this may cause problems typically in flexibility. In contrast, polar-group-containing monomer(s), if used in an excessively low amount (e.g., less than 1 percent by weight based on the total amount of monomer components for constituting the acrylic polymer), may not satisfactorily help the polymer to have a sufficient cohesive strength and to have satisfactorily high strength.

Examples of the multifunctional monomers include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylates, polyester acrylates, and urethane acrylates.

Such multifunctional monomers may be used in an amount not critical, within a range not adversely affecting the advantageous effects of the present invention.

Examples of other copolymerizable monomers than the polar-group-containing monomers and multifunctional monomers include vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride.

Exemplary other copolymerizable monomers than the polar-group-containing monomers include (meth)acrylic esters each having an aromatic hydrocarbon group, such as phenyl(meth)acrylate; (meth)acrylic esters other than the polar-group-containing monomers; vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride.

A preferred embodiment employs a curing reaction by the action of heat and/or an active energy ray using a polymerization initiator such as a thermal initiator and/or a photoinitiator. This is because, in the present invention, the polymerizable composition should be smoothly polymerized within a short time after allowing the surface, to which the polymerizable composition has been applied, to have a three-dimensionally altered shape. Of such curing reactions, a curing reaction by the action of an active energy ray using a photoinitiator is more preferred, because this easily gives a relatively thick polymer sheet, has satisfactory workability, and does not need a large quantity of energy for heating and cooling. Specifically, the polymerizable composition for use in the present invention is preferably a photopolymerizable composition, and particularly preferably a photopolymerizable acrylic composition.

When a photoinitiator is used, it is enough that at least one of the polymerizable composition and the polymer sheet includes the photoinitiator, because the polymerizable monomer(s) in the polymerizable composition is absorbed by the polymer sheet serving as a monomer-absorptive layer in the production method according to the present invention. It is also accepted that the polymer sheet serving as a monomer-absorptive layer is formed from a monomer-absorptive-layer-forming composition including a photoinitiator, and the resulting polymer sheet thereby includes the photoinitiator.

Exemplary photoinitiators usable herein include, but are not limited to, benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators. Each of different photoinitiators may be used alone or in combination.

Specifically, exemplary ketal photoinitiators include 2,2-dimethoxy-1,2-diphenylethan-1-one [e.g., trade name “IRGACURE 651” (supplied by Ciba Japan Ltd.)]. Exemplary acetophenone photoinitiators include 1-hydroxycyclohexyl phenyl ketone [e.g., trade name “IRGACURE 184” (supplied by Ciba Japan Ltd.)], 2,2-diethoxyacetophenone, 2,2-dimethoxy-2-phenylacetophenone, 4-phenoxydichloroacetophenone, and 4-(t-butyl)dichloroacetophenone. Exemplary benzoin ether photoinitiators include benzoin methyl ether, benzoin ethyl ether, benzoin propyl ether, benzoin isopropyl ether, and benzoin isobutyl ether. Exemplary acylphosphine oxide photoinitiators usable herein include trade name “Lucirin TPO” (supplied by BASF AG). Exemplary α-ketol photoinitiators include 2-methyl-2-hydroxypropiophenone and 1-[4-(2-hydroxyethyl)phenyl]-2-methylpropan-1-one. Examples of the aromatic sulfonyl chloride photoinitiators include 2-naphthalenesulfonyl chloride. Examples of the photoactive oxime photoinitiators include 1-phenyl-1,1-propanedione-2-(o-ethoxycarbonyl)-oxime. Exemplary benzoin photoinitiators include benzoin. Exemplary benzil photoinitiators include benzil. Examples of the benzophenone photoinitiators include benzophenone, benzoylbenzoic acid, 3,3′-dimethyl-4-methoxybenzophenone, polyvinylbenzophenone, and α-hydroxycyclohexyl phenyl ketone. Exemplary thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

When the polymerizable composition is a photopolymerizable acrylic composition, the photoinitiator(s) may be used in an amount selected within a range of from 0.01 to 5 parts by weight, and preferably from 0.05 to 3 parts by weight, per 100 parts by weight of the acrylic monomer mixture or a partial polymer thereof as an essential component of the composition, though the amount being not critical.

Exemplary active energy rays to be applied upon the curing reaction by the action of an active energy ray include ionizing radiation such as alpha rays, beta rays, gamma rays, neutron beams, and electron beams; and ultraviolet rays, of which ultraviolet rays are preferred. Conditions of active energy ray irradiation, such as irradiation energy, irradiation time, and irradiation process, are not limited, as long as capable of activating the photoinitiator to cause a polymerization reaction.

Exemplary thermal initiators include azo polymerization initiators [e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine)dihydrochloride], peroxide polymerization initiators (e.g., dibenzoyl peroxide and tert-butyl permaleate), redox polymerization initiators (e.g., an organic peroxide in combination with a vanadium compound; an organic peroxide in combination with dimethylaniline; and a metal salt of naphthenic acid in combination with butyraldehyde, aniline, or acetylbutyrolactone). The thermal initiator(s) may be used in an amount not limited, within such a range as to be usable as a thermal initiator. A redox polymerization initiator, when used as the thermal initiator, enables polymerization at room temperature.

The polymerizable composition may further include a crosslinking agent. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Each of different crosslinking agents may be used alone or in combination.

Examples of the isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanate; as well as a tolylene diisocyanate adduct of trimethylolpropane [trade name “CORONATE L” supplied by Nippon Polyurethane Industry Co., Ltd.] and a hexamethylene diisocyanate adduct of trimethylolpropane [trade name “CORONATE HL” supplied by Nippon Polyurethane Industry Co., Ltd.].

The epoxy crosslinking agents include, for example, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether, bisphenol-S diglycidyl ether, as well as epoxy resins each having two or more epoxy groups per molecule (in the molecule).

Though the crosslinking agent(s) may be used in an amount not limited, typically when the polymerizable composition is a photopolymerizable acrylic composition, the crosslinking agent(s) is used in an amount of preferably from 0.01 to 20 parts by weight, and more preferably from 0.1 to 5 parts by weight, per 100 parts by weight of the acrylic monomer mixture or a partial polymer thereof as the essential component of the composition. This range is preferred for the crosslinking agent(s) not to cause coloring and brittleness after curing or not to impede polymerization due to light absorption.

The polymerizable composition may further include one or more suitable additives according to necessity. Exemplary additives include surfactants (e.g., ionic surfactants, silicone surfactants, and fluorochemical surfactants), tackifiers (e.g., those including a rosin derivative resin, a polyterpene resin, a petroleum resin, or an oil-soluble phenol resin and being solid, semisolid, or liquid at room temperature), plasticizers, fillers, age inhibitors, antioxidants, and colorants (e.g., pigments and dyestuffs). The amounts of such additives may be chosen within ranges not adversely affecting the advantageous effects of the present invention.

The polymerizable composition may further include at least one “material unabsorbable by the polymer sheet (polymer sheet serving as a monomer-absorptive layer)” as a component.

Such a “material unabsorbable by the polymer sheet” may be identified by whether or not the material in question is dissolved in a monomer or monomers for the formation of the polymer sheet serving as a monomer-absorptive layer. Specifically, whether or not a specific substance corresponds to the “material unabsorbable by the polymer sheet” is determined by mixing the specific substance with a monomer for the formation of the polymer sheet (when there are two or more constitutive monomers, a mixture of the constitutive monomers) in a 1:1 ratio (by weight). For example, when the specific substance is not dissolved at all in the monomer for constituting the polymer sheet, the specific substance is identified as a “material unabsorbable by the polymer sheet.” When the specific substance and the constitutive monomer separate from each other at room temperature (about 25° C.) within on hour after mixing (even if they are mixed with each other immediately after mixing), the specific substance is a “material unabsorbable by the polymer sheet.” When a mixture of the specific substance and the constitutive monomer after mixing stably remains in a cloudy state, the specific substance is a “material unabsorbable by the polymer sheet.” As used herein the term “cloudy state” refers to such a state that the mixture is determined as not transparent but cloudy through visual observation. A macromolecular compound having a molecular weight of 10×10⁴ or more is a material unabsorbable by the polymer sheet.

The “material unabsorbable by the polymer sheet (polymer sheet serving as a monomer-absorptive layer)” is not limited, may be an organic substance or an inorganic substance, and may be a solid substance or a substance having a fluidity. Each of different materials unabsorbable by the polymer sheet may be used alone or in combination.

The material unabsorbable by the polymer sheet serving as a monomer-absorptive layer, when contained in the polymerizable composition, may impart any of surface functions, such as hardness, flexibility, adhesiveness, and optical properties, to the polymer sheet having a three-dimensional pattern on surface.

Though not limited, the unabsorbable material is preferably particles. Exemplary particles include inorganic particles such as silica, silicones (silicone powders), calcium carbonate, clay, titanium oxide, talc, lamellar silicates, clay minerals, metal powders, glass, glass beads, glass balloons, alumina balloons, ceramic balloons, titanium white, carbon black, activated carbons, and barium titanate; organic particles such as polyester beads, nylon beads, silicone beads, urethane beads, vinylidene chloride beads, and acrylic balloons; resin particles such as crosslinked acrylic resin particles, crosslinked styrenic resin particles, melamine resin particles, benzoguanamine resin particles, and nylon resin particles; and inorganic-organic hybrid particles. Such particles may be either solid particles or hollow particles (balloons).

Though not critical, the particles each have a particle size (average particle diameter) selected in the range of typically from 0.5 to 500 μm, preferably from 1 to 300 μm, and more preferably 3 to 100 μm. The particles may have any shape not limited, including globular shape such as spherical or oval shape, as well as amorphous, needle-like, rod-like, or plate-like shape. The particles may have holes (depressions) and/or protrusions on their surface. The surface of the particles may have undergone a variety of surface treatment such as treatment for reducing surface tension typically with a silicone compound or a fluorine-containing compound.

Specific examples of the material unabsorbable by the polymer sheet serving as a monomer-absorptive layer include polymers, and oligomers thereof, including acrylic polymers, polyesters, polyurethanes, polyethers, silicones, natural rubbers, synthetic rubbers [of which preferred are synthetic rubbers each containing a styrene component, such as styrene-isoprene-styrene rubber (SIS), styrene-butadiene-styrene rubber (SBS), or styrene-ethylene-butylene-styrene rubber (SEBS)]; tackifiers (tackifier resins) such as rosin tackifier resins, terpene tackifier resins, phenol tackifier resins, hydrocarbon tackifier resins, ketone tackifier resins, polyamide tackifier resins, epoxy tackifier resins, and elastomer tackifier resins; surfactants, antioxidants, organic pigments, plasticizers, solvents (organic solvents) and other liquids; as well as water and aqueous solutions (e.g., aqueous salt solutions, and aqueous acid solutions).

Any of the aforementioned substances, when used as the material unabsorbable by the polymer sheet serving as a monomer-absorptive layer, may impart properties that the substance inherently has to the three-dimensional pattern of the polymer sheet having the three-dimensional pattern on surface. Examples of the properties include flexibility upon the use of a rubber; tackiness upon the use of a tackifier resin; colorability upon the use of a pigment; and water bearing ability upon the use of water or an aqueous solution.

Specifically, when an acrylic polymer is used as the polymer for constituting the polymer sheet serving as a monomer-absorptive layer, preferred examples of the material unabsorbable by this polymer sheet for use in this case include the aforementioned particles, SEBS, polyesters, and silicones.

When an acrylic polymer is used as the polymer for constituting the polymer sheet serving as a monomer-absorptive layer and when particles are used as the material unabsorbable by this polymer sheet in the production method according to the present invention, the particles give an advantage of providing a polymer sheet having a three-dimensional pattern on surface in which the particles are enriched or concentrated in the vicinity of the surface where the three-dimensional pattern is formed. Of such particles, for example, any of crosslinked acrylic particles, lamellar silicates, silica, barium titanate, and titanium oxide, when used, can easily impart surface functions, such as the function of increasing the hardness of the surface, to the polymer sheet.

The amount of the material unabsorbable by the polymer sheet, when included as a component in the polymerizable composition, is not critical. Typically, when the polymerizable composition is a photopolymerizable acrylic composition, the unabsorbable material is included in the composition in an amount of preferably from 0.01 to 50 parts by weight, and more preferably from 0.1 to 20 parts by weight, per 100 parts by weight of the acrylic monomer mixture or a partial polymer thereof as the essential component of the composition. The unabsorbable material, if used in an amount of more than 50 parts by weight, may impede the preparation of the polymer sheet having a three-dimensional pattern on surface or may cause problems in strength. In contrast, the unabsorbable material, if used in an amount of less than 0.01 part by weight, may not exhibit satisfactory effects of its addition.

The polymerizable composition for use in the production method according to the present invention preferably has a formulation identical or similar to that of the monomer-absorptive-layer-forming composition. This is preferred for satisfactory workability and easy formation of the three-dimensional pattern on surface due to easy migration of the polymerizable monomer. Specifically, examples of the polymerizable composition include a polymerizable composition containing, as a polymerizable monomer, at least one of principal monomer component(s) constituting the monomer-absorptive-layer-forming composition; and a polymerizable composition containing, as a polymerizable monomer, a monomer with a partial structure which features the monomer and which is identical to that of the principal monomer component constituting the monomer-absorptive-layer-forming composition. Examples of the featuring partial structure include acrylate structure of an acrylic monomer; and epoxy structure of an epoxy monomer.

For example, when an acrylic polymer is used as the polymer for constituting the polymer sheet serving as a monomer-absorptive layer, an acrylic monomer is preferably used as the polymerizable monomer in the polymerizable composition.

The polymerizable composition may be prepared by mixing and dispersing respective components homogeneously with each other. The polymerizable composition is preferably designed to have an adequate viscosity suitable for coating operation, because the composition is generally formed into a sheet typically by applying the composition to the polymer sheet serving as a monomer-absorptive layer. The viscosity of the polymerizable composition may be regulated typically by incorporation of any of various polymers such as acrylic rubbers and tackifying additives or by partial polymerization typically through light irradiation or heating. The polymerizable composition has a viscosity of preferably from 5 to 50 Pa·s, and more preferably from 10 to 40 Pa·s in terms of viscosity measured with a BH viscometer using a No. 5 rotor under conditions at a number of revolutions of 10 rpm and a measurement temperature of 30° C. The polymerizable composition, if having a viscosity of less than 5 Pa·s, may not remain on the polymer sheet upon coating. In contrast, the polymerizable composition, if having a viscosity of more than 50 Pa·s, may be difficult to be applied due to its excessively high viscosity.

### (Method for Producing Polymer Sheet Having Three-Dimensional Pattern on Surface)

According to the present invention, such a polymer sheet having a three-dimensional pattern on surface is formed through the step [Step (i)] of applying the polymerizable composition to one surface of the polymer sheet serving as a monomer-absorptive layer and allowing the shape of the surface to which the polymerizable composition is applied to three-dimensionally alter; and the step [Step (ii)] of subjecting the resulting article to polymerization to form a three-dimensional pattern on the surface.

In Step (i), the polymerizable composition is applied to one surface of the polymer sheet serving as a monomer-absorptive layer, namely, to the monomer-absorptive surface of the polymer sheet. When the polymerizable composition is applied, the surface of the polymer sheet to which the polymer sheet has been applied alters in shape from a smooth (flat) shape to a three-dimensional shape. Specifically, the surface to which the polymerizable composition has been applied is smooth or flat immediately after the application, but a three-dimensional pattern is formed thereon with time. After the formation of the three-dimensional pattern, the resulting article is subjected to polymerization to cure while maintaining the structure to thereby form a three-dimensional pattern on the surface, in the production method according to the present invention.

Phenomena occurring in Step (i) are probably as follows. The application of the polymerizable composition to the polymer sheet serving as a monomer-absorptive layer induces an interaction between the polymer sheet and at least one of the polymerizable monomer(s), and the interacted polymerizable monomer(s) is at least partially absorbed into the polymer sheet. This causes the polymer sheet to have an increased volume (to swell) and causes the applied polymerizable composition to change in volume and/or to migrate (change in shape).

In Step (i), the resulting structure obtained by the application of polymerizable composition to the polymer sheet serving as a monomer-absorptive layer is left stand until the surface to which the polymerizable composition has been applied alters in shape so as to have a desired three-dimensional structure.

When polymerization of the structure proceeds, the structure may generally be cured, and this may impede the formation of a desired three-dimensional structure. To avoid this, the structure is preferably left stand in such an environment for the polymerization as to proceed little or in such an environment for a polymerization reaction as not to occur.

Though not critical, the standing time (time duration between the application of the polymerizable composition to the polymer sheet and polymerization) in the method for producing the polymer sheet according to the present invention is preferably 1 minute or longer, more preferably 2 minutes or longer, and furthermore preferably 3 minutes or longer, for satisfactory productivity and formation of the three-dimensional structure. The duration of Step (ii) is generally one hour or shorter (and preferably 30 minutes or shorter). An excessively long standing may cause evaporation of the polymerizable composition.

In general, Step (i) does not employ a cover film. This is because a cover film, if affixed to the surface of the polymer sheet serving as a monomer-absorptive layer to which the polymerizable composition has been applied, may impede the formation of a three-dimensional pattern on the surface. Specifically, in a preferred embodiment of the method for producing the polymer sheet according to the present invention, a polymerizable composition is applied to one surface of a polymer sheet, and the surface shape is allowed to alter three-dimensionally without the affixation of a cover film to the applied surface, and subjecting the resulting article to polymerization/curing to form a three-dimensional shape on the surface, in which the polymerizable composition includes, as an essential component, a monomer mixture including at least one polymerizable monomer absorbable by the polymer sheet, or a partial polymer of the monomer mixture. In this connection, a cover film may be used after the production of a polymer sheet having a three-dimensional pattern on surface by the production method according to the present invention, in order to protect the polymer sheet having a three-dimensional pattern on surface.

In Step (ii), the structure obtained in Step (i) is cured through polymerization to thereby form a three-dimensional pattern (steric pattern) of a polymer sheet having the three-dimensional pattern on surface. The structure herein is one which is obtained by applying the polymerizable composition to the polymer sheet serving as a monomer-absorptive layer to give a structure, and leaving the structure stand to form a desired three-dimensional structure on the surface to which the polymerizable composition has been applied.

Examples of the polymerization process include thermal polymerization using a polymerizable composition containing a thermal initiator; and photopolymerization using a polymerizable composition containing a photoinitiator. Among them, photopolymerization is preferably employed, because this technique easily gives a thick polymer sheet, has good workability, and does not need a large quantity of energy for heating and cooling, as described above.

Conditions for polymerization are not critical, as long as a three-dimensional pattern (steric pattern) of polymer is formed through polymerization/curing. Exemplary conditions include light source or heat source, irradiation energy or heat energy, irradiation procedure or heating procedure, irradiation time or heating time, commencing time of irradiation or heating, and ending time of irradiation or heating. When photopolymerization is employed, an active energy ray may be applied from one side or from both sides.

Exemplary active energy rays to be applied upon the photopolymerization include ionizing radiation such as alpha rays, beta rays, gamma rays, neutron beams, and electron beams; and ultraviolet rays, of which ultraviolet rays are preferred for good workability.

When the polymerization in Step (ii) is performed by photopolymerization through ultraviolet ray irradiation, exemplary procedures include irradiation with an ultraviolet ray typically using a black-light lamp, chemical lamp, high-pressure mercury lamp, or metal halide lamp. When the polymerization is performed by heating, exemplary procedures include known heating procedures such as heating with an electric heater, and heating with an electromagnetic wave such as infrared ray.

The method for producing a polymer sheet having a three-dimensional pattern on surface as described above is simple and can produce a polymer sheet having a three-dimensional pattern on surface with good workability. The method helps the resulting polymer sheet to have a further larger surface area. When employing photopolymerization, the method does not need, for example, a heating step for accelerating polymerization and a cooling step for suppressing runaway reactions, and excels in energy saving.

### (Polymer Sheet Having Three-Dimensional Pattern on Surface)

A polymer sheet having a three-dimensional pattern on surface produced by the production method according to the present invention has a three-dimensional pattern on at least one surface thereof. The polymer sheet therefore excels in graphical design function and has a large surface area.

The three-dimensional pattern of the polymer sheet having the three-dimensional pattern on surface has a random or unspecified shape which includes, for example, pleated ridges (pleats, ribs, or ridge-like protrusions) and depressed valleys (depressions) and which has a shape such as an irregular framework shape in which pleated ridges irregularly intersect one another, or a melon-network shape like the surface of muskmelon (a plant) (see FIGS. 2 to 6, 10, and 11).

Though not critical, the ridges in the polymer sheet having a three-dimensional pattern on surface have a height of typically from about 10 to about 2000 μm, and preferably from about 100 to about 500 μm. The height herein is indicated as the difference between the deepest portion of the valleys and the highest portion of the ridges.

Though not critical, the polymer sheet having a three-dimensional pattern on surface has a total thickness of typically from about 50 to about 3000 μm, and preferably from about 200 to about 1000 μm. The total thickness corresponds to the total of the thickness of the polymer sheet serving as a monomer-absorptive layer and the thickness of the polymer portion obtained by subjecting the structure, which has been formed from the polymerizable composition, to polymerization. Specifically, the total thickness refers to the thickness of the thickest portion in the entire polymer sheet having a three-dimensional pattern on surface. When the polymer sheet serving as a monomer-absorptive layer in the polymer sheet having a three-dimensional pattern on surface is present as a monomer-absorptive layer provided on at least one side of a backing (polymer-sheet backing), the total thickness of the polymer sheet having a three-dimensional pattern on surface does not include the thickness of the backing.

The polymer sheet having a three-dimensional pattern on surface as mentioned above is usable typically in graphical design or antiskid applications utilizing the surface shape or applications of adsorption, absorption, or desorption of a substance utilizing its large surface area. The polymer sheet is therefore used typically in or as tablecloths, flooring materials, ceiling materials, wall-coverings, automotive interior materials, and armoring materials for portable electronic appliances such as cellular phones.

### EXAMPLES

The present invention will be illustrated in further detail with reference to several working examples below. It should be noted, however, that these examples are never construed to limit the scope of the present invention.

### Preparation Example 1 for Photopolymerizable Syrup

A monomer mixture was prepared by mixing 90 parts by weight of 2-ethylhexyl acrylate with 10 parts by weight of acrylic acid as monomer components, and the monomer mixture was stirred with 0.1 part by weight of a photoinitiator (trade name “IRGACURE 651” supplied by Ciba Japan Ltd.) in a four-neck separable flask equipped with a stirrer, a thermometer, a nitrogen gas inlet tube, and a condenser to give a uniform mixture, followed by bubbling with nitrogen gas for one hour to remove dissolved oxygen. The resulting mixture was polymerized by applying, from the outside of the flask, an ultraviolet ray emitted from a black-light lamp. At the time when the mixture had a suitable viscosity, the lamp was turned out, the nitrogen blowing was stopped, and thereby a partially polymerized composition (syrup) having a degree of polymerization of 7% (hereinafter also referred to as “Photopolymerizable Syrup (A)”) was prepared.

### Preparation Example 2 for Photopolymerizable Syrup

As a monomer component, 100 parts by weight of butyl acrylate was stirred with 0.1 part by weight of a photoinitiator (trade name “IRGACURE 651” supplied by Ciba Japan Ltd.) in a four-neck separable flask equipped with a stirrer, a thermometer, a nitrogen gas inlet tube, and a condenser to give a uniform mixture, followed by bubbling with nitrogen gas for one hour to remove dissolved oxygen. The resulting mixture was polymerized by applying, from the outside of the flask, an ultraviolet ray emitted from a black-light lamp. At the time when the mixture had a suitable viscosity, the lamp was turned out, the nitrogen blowing was stopped, and thereby a partially polymerized composition (syrup) having a degree of polymerization of 7% (hereinafter also referred to as “Photopolymerizable Syrup (B)”) was prepared.

### Preparation Example 3 for Photopolymerizable Syrup

As a monomer component, 100 parts by weight of isobornyl acrylate was stirred with 0.1 part by weight of a photoinitiator (trade name “IRGACURE 651” supplied by Ciba Japan Ltd.) in a four-neck separable flask equipped with a stirrer, a thermometer, a nitrogen gas inlet tube, and a condenser to give a uniform mixture, followed by bubbling with nitrogen gas for one hour to remove dissolved oxygen. The resulting mixture was polymerized by applying, from the outside of the flask, an ultraviolet ray emitted from a black-light lamp. At the time when the mixture had a suitable viscosity, the lamp was turned out, the nitrogen blowing was stopped, and thereby a partially polymerized composition (syrup) having a degree of polymerization of 7% (hereinafter also referred to as “Photopolymerizable Syrup (C)”) was prepared.

### Preparation Example 1 for Photopolymerizable Composition

A photopolymerizable composition (hereinafter also referred to as “Photopolymerizable Composition (A)”) was prepared by mixing 100 parts by weight of Photopolymerizable Syrup (A) with 0.1 part by weight of a crosslinking agent, 1,6-hexanediol diacrylate (trade name “NK Ester A-HD” supplied by Shin-Nakamura Chemical Co., Ltd.).

### Preparation Example 2 for Photopolymerizable Composition

A photopolymerizable composition (hereinafter also referred to as “Photopolymerizable Composition (B)”) was prepared by dissolving and incorporating 2 parts by weight of a photoinitiator (trade name “IRGACURE 651” supplied by Ciba Japan Ltd.) and 0.3 part by weight of a crosslinking agent dipentaerythritol hexaacrylate (trade name “KAYARAD DPHA” supplied by Nippon Kayaku Co., Ltd.) in 100 parts by weight of Photopolymerizable Syrup (A).

### Preparation Example 3 for Photopolymerizable Composition

A photopolymerizable composition (hereinafter also referred to as “Photopolymerizable Composition (C)”) was prepared by dissolving and incorporating 2 parts by weight of a photoinitiator (trade name “IRGACURE 651” supplied by Ciba Japan Ltd.) and 0.3 part by weight of a crosslinking agent dipentaerythritol hexaacrylate (trade name “KAYARAD DPHA” supplied by Nippon Kayaku Co., Ltd.) in 100 parts by weight of Photopolymerizable Syrup (B).

### Preparation Example 4 for Photopolymerizable Composition

A photopolymerizable composition (hereinafter also referred to as “Photopolymerizable Composition (D)”) was prepared by mixing 0.1 part by weight of a crosslinking agent 1,6-hexanediol diacrylate (trade name “NK Ester A-HD” supplied by Shin-Nakamura Chemical Co., Ltd.) with 100 parts by weight of Photopolymerizable Syrup (C).

### Preparation Example 5 for Photopolymerizable Composition

A photopolymerizable composition (hereinafter also referred to as “Photopolymerizable Composition (E)”) was prepared by mixing 2 parts by weight of a photoinitiator (trade name “IRGACURE 651” supplied by Ciba Japan Ltd.), 0.3 part by weight of a crosslinking agent dipentaerythritol hexaacrylate (trade name “KAYARAD DPHA” supplied by Nippon Kayaku Co., Ltd.), and 5 parts by weight of crosslinked polymer particles having an average particle size of 5 μm (trade name “MX-500” supplied by Soken Chemical & Engineering Co., Ltd.) with 100 parts by weight of Photopolymerizable Syrup (A).

### (Cover Film)

As a cover film, was used a 38-μm thick biaxially oriented poly(ethylene terephthalate) film (trade name “MRN38” supplied by Mitsubishi Plastics, Inc., or “MRF38” supplied by Mitsubishi Plastics, Inc.) one side of which had been releasably treated with a silicone mold-release agent (release agent).

### Production Example 1 for PET-Supported Polymer Sheet

Photopolymerizable Composition (A) was applied to one surface of a PET backing so as to form a coat layer having a thickness after curing of 30 μm, onto which the cover film was affixed so that the releasably treated surface was in contact with the layer. The PET backing is a 38-μm thick biaxially oriented poly(ethylene terephthalate) film, trade name “Lumirror S10” supplied by Toray Industries Inc. Next, an ultraviolet ray (irradiance: 5 mW/cm²) was applied for 3 minutes using a black-light lamp to cure the layer, and thereby yielded a polymer sheet. The cover film was then removed from the polymer sheet by peeling, and thereby a polymer sheet provided on the PET backing (hereinafter also referred to as “PET-Supported Polymer Sheet (A)”) was produced.

### Production Example 2 for PET-Supported Polymer Sheet

Photopolymerizable Composition (D) was applied to one surface of a PET backing so as to form a coat layer having a thickness after curing of 30 μm, onto which the cover film was affixed so that the releasably treated surface was in contact with the layer. The PET backing is a 38-μm thick biaxially oriented polyethylene terephthalate) film, trade name “Lumirror S10” supplied by Toray Industries Inc. Next, an ultraviolet ray (irradiance: 5 mW/cm²) was applied for 3 minutes using a black-light lamp to cure the layer, and thereby yielded a polymer sheet. The cover film was then removed from the polymer sheet by peeling, and thereby a polymer sheet provided on the PET backing (hereinafter also referred to as “PET-Supported Polymer Sheet (B)”) was produced.

### Production Example 3 for PET-Supported Polymer Sheet

Photopolymerizable Syrup (A) was applied to one surface of a PET backing so as to form a coat layer having a thickness after curing of 50 μm, onto which the cover film was affixed so that the releasably treated surface was in contact with the layer. The PET backing is a 38-μm thick biaxially oriented poly(ethylene terephthalate) film, trade name “Lumirror S10” supplied by Toray Industries Inc. Next, an ultraviolet ray (irradiance: 5 mW/cm²) was applied for 3 minutes using a black-light lamp to cure the layer, and thereby yielded a polymer sheet. The cover film was then removed from the polymer sheet by peeling, and thereby a polymer sheet provided on the PET backing (hereinafter also referred to as “PET-Supported Polymer Sheet (C)”) was produced.

### Production Example 4 for PET-Supported Polymer Sheet

Photopolymerizable Composition (A) was applied to one surface of a PET backing so as to form a coat layer having a thickness after curing of 100 μm, onto which the cover film was affixed so that the releasably treated surface was in contact with the layer. The PET backing is a 38-μm thick biaxially oriented poly(ethylene terephthalate) film, trade name “Lumirror S10” supplied by Toray Industries Inc. Next, an ultraviolet ray (irradiance: 5 mW/cm²) was applied for 3 minutes using a black-light lamp to cure the layer, and thereby yielded a polymer sheet. The cover film was then removed from the polymer sheet by peeling, and thereby a polymer sheet provided on the PET backing (hereinafter also referred to as “PET-Supported Polymer Sheet (D)”) was produced.

### Production Example 5 for PET-Supported Polymer Sheet

Photopolymerizable Composition (A) was applied to one surface of a PET backing so as to form a coat layer having a thickness after curing of 200 μm, onto which the cover film was affixed so that the releasably treated surface was in contact with the layer. The PET backing is a 38-μm thick biaxially oriented polyethylene terephthalate) film, trade name “Lumirror S10” supplied by Toray Industries Inc. Next, an ultraviolet ray (irradiance: 5 mW/cm²) was applied for 3 minutes using a black-light lamp to cure the layer, and thereby yielded a polymer sheet. The cover film was then removed from the polymer sheet by peeling, and thereby a polymer sheet provided on the PET backing (hereinafter also referred to as “PET-Supported Polymer Sheet (E)”) was produced.

### Example 1

Photopolymerizable Composition (B) was applied onto the polymer sheet of PET-Supported Polymer Sheet (A) to a thickness of 100 μm. As a result of leaving the coated polymer sheet stand for 10 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

When the polymer sheet was retrieved from PET-Supported Polymer Sheet (A) and immersed in an excess amount of a monomer solution having the same composition (90 parts by weight of 2-ethylhexyl acrylate and 10 parts by weight of acrylic acid) as with Photopolymerizable Composition (B) at 25° C., the polymer sheet increased in weight 4.2 times as heavy as the initial weight 75 seconds later and 12.6 times as heavy as the initial weight 3 days later.

### Example 2

Photopolymerizable Composition (B) was applied onto the polymer sheet of PET-Supported Polymer Sheet (A) to a thickness of 200 μm. As a result of leaving the coated polymer sheet stand for 5 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

### Example 3

Photopolymerizable Composition (B) was applied onto the polymer sheet of PET-Supported Polymer Sheet (A) to a thickness of 400 μm. As a result of leaving the coated polymer sheet stand for 3 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

### Example 4

Photopolymerizable Composition (C) was applied onto the polymer sheet of PET-Supported Polymer Sheet (B) to a thickness of 100 μm. As a result of leaving the coated polymer sheet stand for 10 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

When the polymer sheet retrieved from PET-Supported Polymer Sheet (B) was immersed in an excess amount of a monomer solution having the same composition (10 parts by weight of butyl acrylate) as with Photopolymerizable Composition (C) at 25° C., the polymer sheet increased in weight 5.7 times as heavy as the initial weight 75 seconds later and 11.2 times as heavy as the initial weight 3 days later.

### Example 5

Photopolymerizable Composition (E) was applied onto the polymer sheet of PET-Supported Polymer Sheet (A) to a thickness of 100 μm. As a result of leaving the coated polymer sheet stand for 10 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

The crosslinked polymer particles having an average particle size of 5 μm and being contained in Photopolymerizable Composition (E) are a material unabsorbable by the polymer sheet.

### Example 6

Photopolymerizable Composition (B) was applied onto the polymer sheet of PET-Supported Polymer Sheet (A) to a thickness of 100 μm. As a result of leaving the coated polymer sheet stand for 10 minutes after coating, a three-dimensional pattern was formed on the surface of the coated side. Next, while maintaining the coated side upward, the structure was subjected to ultraviolet ray irradiation using an UV irradiator equipped with a conveyor belt and a Fusion H Bulb as an UV lamp. The ultraviolet ray irradiation fixed the three-dimensional pattern and thereby yielded a polymer sheet having the three-dimensional pattern on the sheet surface.

The ultraviolet ray irradiation was performed by allowing the structure to pass through the UV irradiator equipped with a conveyor belt five times each at a conveyor speed of 3.5 meters per minute. The irradiation was performed at an UV irradiance per one pass of 290 mW/cm² in a light quantity of 830 mJ/cm².

### Comparative Example 1

Photopolymerizable Composition (B) was applied to one surface of a PET backing (38-μm thick biaxially oriented polyethylene terephthalate) film, trade name “Lumirror S10” supplied by Toray Industries Inc.) to a thickness of 100 μm, by the procedure of Example 1. However, no three-dimensional pattern was formed on the surface of the coated side even after a lapse of one hour from coating.

When the PET backing was immersed in an excess amount of a monomer solution having the same composition (90 parts by weight of 2-ethylhexyl acrylate and 10 parts by weight of acrylic acid) as with Photopolymerizable Composition (B) at 25° C., the PET backing increased in weight 1.1 times as heavy as the initial weight 75 seconds later and 1.1 times as heavy as the initial weight 3 days later.

### Comparative Example 2

Photopolymerizable Composition (B) was applied to one surface of a PET backing (38-μm thick biaxially oriented poly(ethylene terephthalate) film, trade name “Lumirror S10” supplied by Toray Industries Inc.) to a thickness of 200 μm, by the procedure of Example 2. However, no three-dimensional pattern was formed on the surface of the coated side even after a lapse of one hour from coating.

### Comparative Example 3

Photopolymerizable Composition (B) was applied to one surface of a PET backing (38-μm thick biaxially oriented poly(ethylene terephthalate) film, trade name “Lumirror S10” supplied by Toray Industries Inc.) to a thickness of 400 μm by the procedure of Example 3. However, no three-dimensional pattern was formed on the surface of the coated side even after a lapse of one hour from coating.

### Comparative Example 4

Photopolymerizable Composition (C) was applied to one surface of a PET backing (38-μm thick biaxially oriented poly(ethylene terephthalate) film, trade name “Lumirror S10” supplied by Toray Industries Inc.) to a thickness of 100 μm by the procedure of Example 4. However, no three-dimensional pattern was formed on the surface of the coated side even after a lapse of one hour from coating.

When the PET backing was immersed in an excess amount of a monomer solution having the same composition (100 parts by weight of butyl acrylate) as with Photopolymerizable Composition (C) at 25° C., the PET backing increased in weight 1.1 times as heavy as the initial weight 75 seconds later and 1.1 times as heavy as the initial weight 3 days later.

### Comparative Example 5

Photopolymerizable Composition (E) was applied to one surface of a PET backing (38-μm thick biaxially oriented polyethylene terephthalate) film, trade name “Lumirror S10” supplied by Toray Industries Inc.) to a thickness of 100 μm by the procedure of Example 5. However, no three-dimensional pattern was formed on the surface of the coated side even after a lapse of one hour from coating.

### Comparative Example 6

Photopolymerizable Composition (B) was applied onto the polymer sheet of PET-Supported Polymer Sheet (C) to a thickness of 200 μm. However, no three-dimensional pattern was formed on the surface of the coated side even after a lapse of one hour from coating.

When the polymer sheet retrieved from PET-Supported Polymer Sheet (C) was immersed in an excess amount of a monomer solution having the same composition (90 parts by weight of 2-ethylhexyl acrylate and 10 parts by weight of acrylic acid) as with Photopolymerizable Composition (B) at 25° C., the polymer sheet increased in weight 3.8 times as heavy as the initial weight 75 seconds later, but, 3 days later, almost dissolved and decreased in weight 0.03 time as heavy as the initial weight.

### Comparative Example 7

Photopolymerizable Composition (B) was applied onto the polymer sheet of PET-Supported Polymer Sheet (D) to a thickness of 50 μm. However, no three-dimensional pattern was formed on the surface of the coated side even after a lapse of one hour from coating.

### Comparative Example 8

Photopolymerizable Composition (B) was applied onto the polymer sheet of PET-Supported Polymer Sheet (E) to a thickness of 50 μm. However, no three-dimensional pattern was formed on the surface of the coated side even after a lapse of one hour from coating.

### (Evaluation)

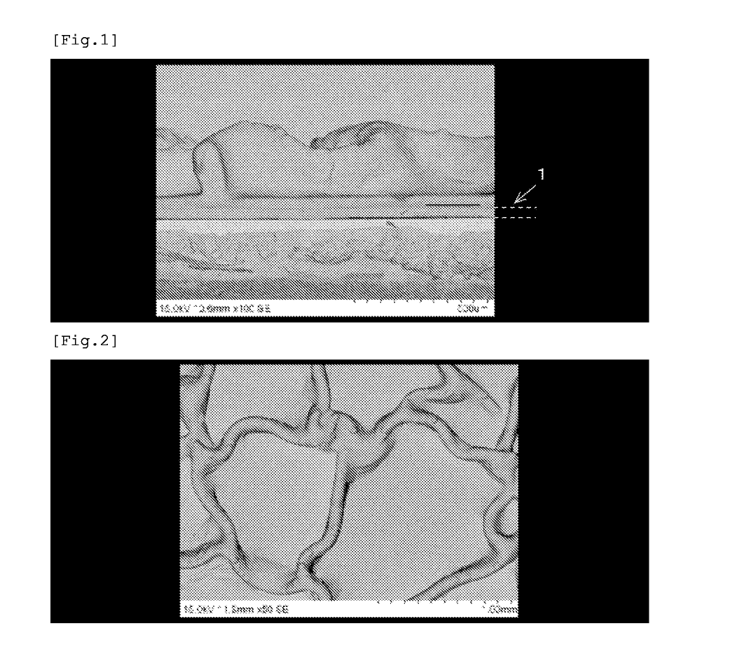

The surface structure and cross-sectional structure of the examples and comparative examples were observed visually or under a scanning electron microscope (SEM) (device name “S-4800” supplied by Hitachi High-Technologies Corporation). The results are illustrated in FIGS. 1 to 12.

In FIG. 1, one graduation on the scale is 50 μm.

In FIG. 2, one graduation on the scale is 100 μm.

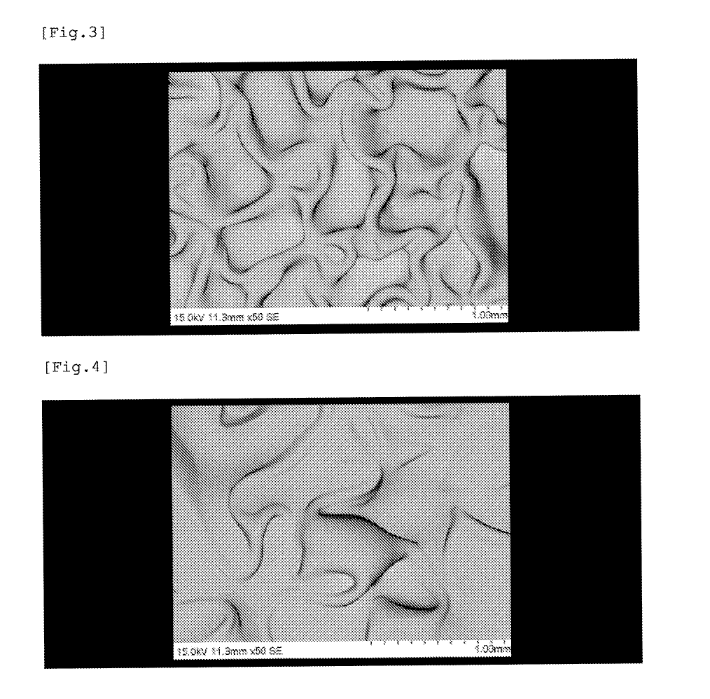

In FIG. 3, one graduation on the scale is 100 μm.

In FIG. 4, one graduation on the scale is 100 μm.

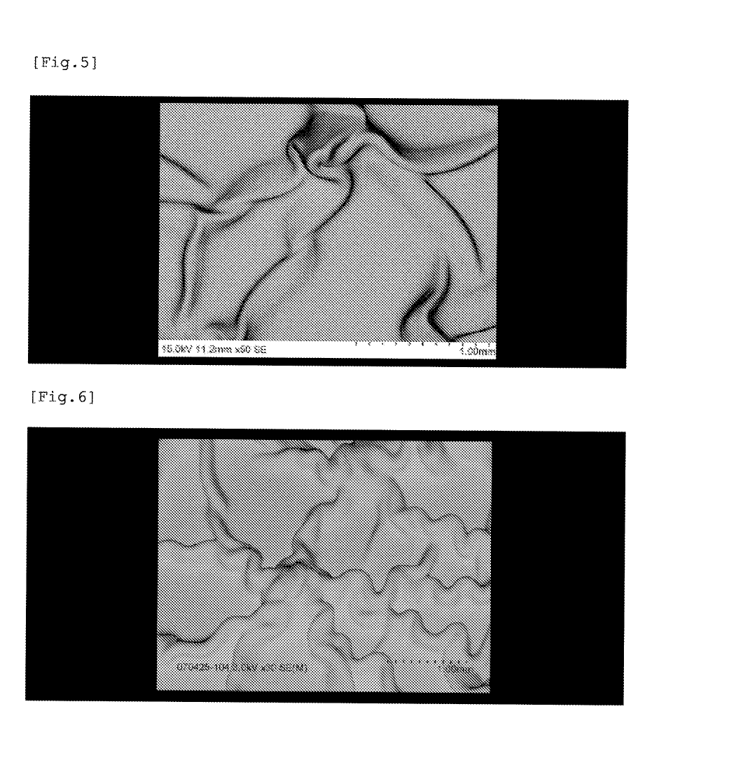

In FIG. 5, one graduation on the scale is 100 μm.

In FIG. 6, one graduation on the scale is 100 μm.

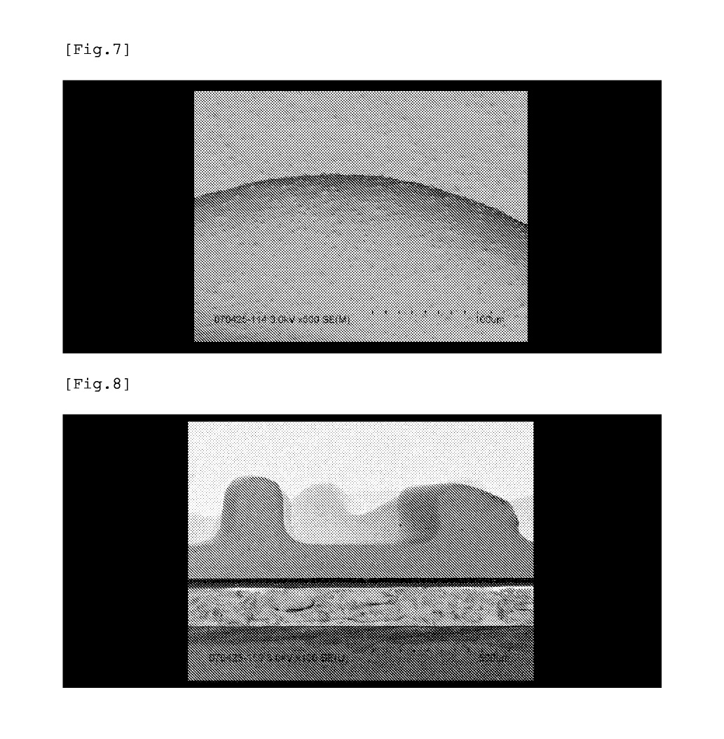

In FIG. 7, one graduation on the scale is 10 μm.

In FIG. 8, one graduation on the scale is 50 μm.

In FIG. 9, one graduation on the scale is 10 μm.

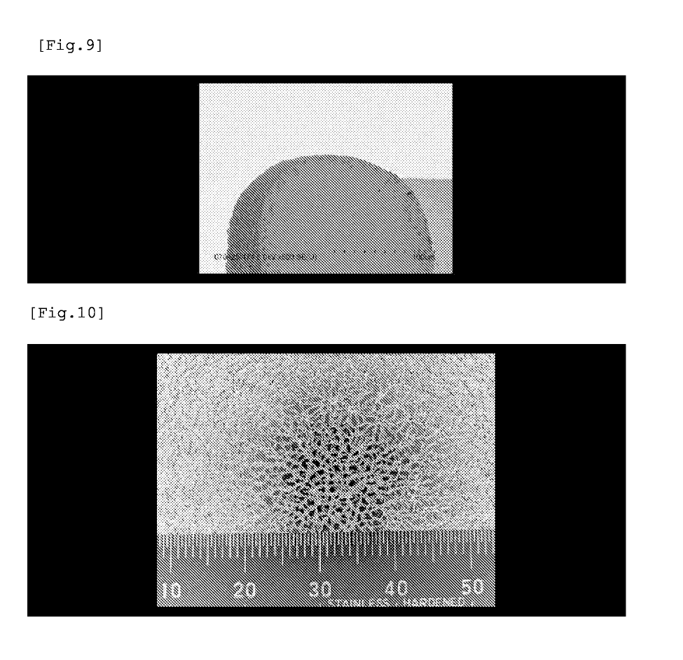

In FIG. 10, one graduation on the scale is 0.5 mm.

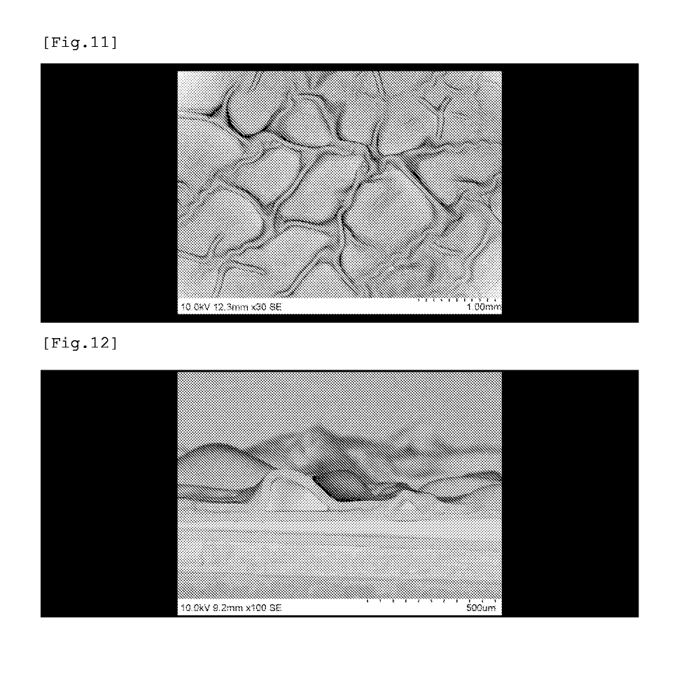

In FIG. 11, one graduation on the scale is 100 μm.

In FIG. 12, one graduation on the scale is 50 μm.

The production method employed in the examples did not need a heating step and a cooling step and did not consume a large quantity of energy. In addition, the method gave polymer sheets having a three-dimensional pattern on surface with good workability in a simple manner without the need of providing extra steps such as heating step, cooling step, and mold-releasing step.

### INDUSTRIAL APPLICABILITY

The polymer sheets each having a three-dimensional pattern on surface are usable typically in graphical design or antiskid applications utilizing the surface shape or in applications of adsorption, absorption, or desorption of a substance utilizing their large surface area. The polymer sheets are therefore used typically in or as tablecloths, flooring materials, ceiling materials, wall-coverings, automotive interior materials, and armoring materials for portable electronic appliances such as cellular phones.

### REFERENCE SIGNS LIST

1 PET backing

1. A method for producing a polymer sheet having a three-dimensional pattern on surface, the method comprising the steps of applying a polymerizable composition to one surface of a polymer sheet and allowing the surface to have a three-dimensionally altered shape, the polymerizable composition including a monomer mixture or a partial polymer thereof as an essential component, the monomer mixture including at least one polymerizable monomer absorbable by the polymer sheet; and thereafter performing polymerization/curing to form a three-dimensional pattern on the surface of the polymer sheet.

2. The method for producing a polymer sheet having a three-dimensional pattern, according to claim 1, the method comprising the steps of applying the polymerizable composition to one surface of the polymer sheet and allowing the surface to have a three-dimensionally altered shape without affixation of a cover film onto the applied surface, the polymerizable composition including the monomer mixture or a partial polymer thereof as an essential component, the monomer mixture including at least one polymerizable monomer absorbable by the polymer sheet; and thereafter performing polymerization/curing.

3. The method for producing a polymer sheet having a three-dimensional pattern, according to claim 1, wherein the polymerizable composition applied to one surface of the polymer sheet is left for one minute or longer before being subjected to polymerization.

4. The method for producing a polymer sheet having a three-dimensional pattern, according to claim 1, wherein the polymerizable composition further includes at least one material unabsorbable by the polymer sheet.

5. The method for producing a polymer sheet having a three-dimensional pattern, according to claim 1, wherein either one or both of the polymer sheet and the polymerizable composition includes a photoinitiator.

6. The method for producing a polymer sheet having a three-dimensional pattern, according to claim 1, wherein the polymerization/curing is performed through irradiation with active energy ray.

7. The method for producing a polymer sheet having a three-dimensional pattern, according to claim 6, wherein the active energy ray is ultraviolet ray.
